(19) United States
(12) Patent Application Publication
(10) Pub. No.: US 2013/0118857 A1
(43) Pub. Date: May 16, 2013

(54) CENTRIFUGAL UNIT AND CLUTCH

(71) Applicant: ZF Friedrichshafen AG, Friedrichshafen (DE)

(72) Inventor: Jan WITTHOLZ, Grafenrheinfeld (DE)

(73) Assignee: ZF Friedrichshafen AG, Friedrichshafen (DE)

(21) Appl. No.: 13/676,835

(22) Filed: Nov. 14, 2012

(30) Foreign Application Priority Data
Nov. 14, 2011 (EP) 11188942.4

(51) Int. Cl. F16D 43/06

(52) U.S. Cl. CPC F16D 43/06
USPC 192/104 R

(57) ABSTRACT

A centrifugal unit for a clutch of a motor vehicle includes a first structural component part, a second structural component part which is coupled to the first structural component part so as to be fixed with respect to rotation relative to it. The first structural component part and the second structural component part are constructed in such a way that, when a limiting rotational speed is exceeded, a distance between the first structural component part and second structural component part increases along an axial direction, and a return spring element which causes a force between the first structural component part and second structural component part in such a way that the distance between the first structural component part and second structural component part adopts a neutral value when the centrifugal unit is at a standstill. The second structural component part is constructed so as to furnish a mechanical connection to a clutch disk of the clutch for transmitting a torque. The first structural component part is formed so as to contact or be brought into contact with a pressing force-generating element of the clutch.

### CROSS-REFERENCED TO RELATED APPLICATION

This application claims priority to European Application No. EP 11188942, filed Nov. 14, 2011, the content of which is incorporated by reference herein.

### BACKGROUND OF THE INVENTION

1. Field of the Invention

The present invention is directed to a centrifugal unit and a clutch such as can be used, for example, in the automotive field, especially, for example, in passenger cars and in car racing.

2. Description of the Related Art

The operation of a clutch in a motor vehicle is perceived by many drivers as burdensome or at least tedious. Particularly starting during which, in a conventional dry clutch, the bite point of the clutch must be held briefly, continues to awaken in drivers the urge to let operation of the clutch be carried out automatically. Therefore, particularly in this area, centrifugal clutches were used already in the 1950s. The so-called “Saxomat”, for example, used an additional centrifugal clutch in which centrifugal weights supported by rolling element bearings rolled along ramps and made it possible to interrupt the flow of force between engine and transmission while the motor vehicle was stationary.

Thus, conventionally, the driver is relieved in this respect by a centrifugal clutch which engages the vehicle automatically. Conventional centrifugal clutches are based, for example, on radially opening shoes or disk packs which are actuated by centrifugal levers.

Accordingly, German Published Application No. DE 10 2004 030 280 is directed to a centrifugal clutch in which a pressing plate is pressed against a clutch disk in a housing arrangement by rolling elements and a diaphragm spring acting as lever mechanism. In this case, the diaphragm spring is arranged inside the housing of the centrifugal clutch. However, the centrifugal clutch described in this document does not allow, for example, an immediate gear change because this centrifugal clutch cannot be selectively disengaged.

In view of this, there is a need to provide a centrifugal unit for a clutch of a motor vehicle which allows the clutch to be selectively disengaged, for example, for changing gears. Likewise, there is a corresponding need to provide a clutch which allows the clutch to be selectively disengaged for changing gears on the one hand but which also relieves the driver by automatically engaging when starting.

### SUMMARY OF THE INVENTION

A centrifugal unit for a clutch of a motor vehicle according to an embodiment example comprises a first structural component part, a second structural component part which is coupled to the first structural component part so as to be fixed with respect to rotation relative to it with respect to an axial direction. The first structural component part and the second structural component part are constructed in such a way that, when a limiting rotational speed is exceeded, a distance between the first structural component part and second structural component part increases along the axial direction starting from a neutral value when the centrifugal unit is at a standstill. A return spring element which causes a force between the first structural component part and second structural component part in such a way that the distance between the first structural component part and second structural component part adopts the neutral value when the centrifugal unit is at a standstill. In this instance, the second structural component part is constructed so as to furnish a mechanical connection to a clutch disk of the clutch for transmitting a torque. The first structural component part is formed so as to contact or be brought into contact with a pressing force-generating element of the clutch so that the mechanical connection to the clutch disk is provided or strengthened by means of the increased distance between the first structural component part and the second structural component part by means of the pressing force-generating element.

A clutch of a motor vehicle according to an embodiment of the invention comprises a clutch disk, a centrifugal unit according to the embodiment mentioned above, a pressing force-generating element which is constructed in such a way that, when the distance between the first structural component part and the second structural component part of the centrifugal unit increases, a pressing force is exerted along the axial direction on the centrifugal unit and the clutch disk so that the torque can be transmitted. The clutch also includes a housing cage which is connected to the pressing force-generating element and centrifugal unit so as to be fixed with respect to relative rotation, and a disengagement unit which is so arranged and constructed that a pressing force exerted by the pressing force-generating element can be suppressed or reduced by the disengagement unit so that the mechanical connection between the clutch disk and centrifugal unit can be disengaged.

A centrifugal unit for a clutch according to an embodiment and a clutch for a motor vehicle according to an embodiment of the invention are based on the insight that a selective disengagement of the clutch, for example, for a gear change, can be achieved in that the first structural component part of the centrifugal unit is so constructed and arranged that it contacts or can be brought into contact with the pressing force-generating element of the clutch so that by means of the increased distance between the first structural component part and the second structural component part the mechanical connection to the clutch disk of the clutch is furnished or strengthened by the pressing force-generating element thereof. In other words, in a centrifugal unit according to an embodiment of the invention, the pressing force can be transmitted by the pressing force-generating element via the first structural component part and second structural component part of the centrifugal unit to the clutch disk of the clutch to furnish the mechanical connection for transmitting torque. Expressed in yet another way, the clutch can be engaged by means of the pressing force-generating element thereof by increasing the distance between the first structural component part and second structural component part of the centrifugal unit.

The mechanical connection for transmitting a torque can be carried out by providing a force-fitting or frictionally engaging connection. A force-fitting or frictionally engaging connection is brought about by static friction which accordingly presupposes a normal force component between the parts to be connected. The normal force component is brought about by the pressing force-generating element of the clutch in the form of pressing force which presses the second structural component part of the centrifugal unit against a friction surface of the clutch disk by the intermediary of the first structural component part and the further components of the centrifugal unit in order to furnish the mechanical connection for transmitting the torque.

To this end, in centrifugal units according to an embodiment the first and/or the second structural component part are/is often constructed so as to be substantially plate-shaped or disk-shaped. Accordingly, the second structural component part generally has, at one side facing the clutch disk of the clutch, a pressing surface which is at least partially ring-shaped or annular, for example. In so doing, the pressing surface is often oriented substantially perpendicular to the axial direction.

Accordingly, in the assembled state, the first structural component part and second structural component part can at least partially form a housing of the centrifugal unit, which housing is not necessarily closed, wherein the second structural component part of the clutch disk and the first structural component part face the pressing force-generating element. Correspondingly, the second structural component part often has the substantially annular or ring-shaped pressing surface which is constructed so that it can be brought into contact with the clutch disk indirectly, for example, via a friction facing which can be arranged thereon or a separate friction plate, or directly. The first structural component part likewise typically has a corresponding contact surface by which it enters into mechanical contact with the pressing force-generating element of the clutch when the distance between the first structural component part and second structural component part is increased so as to furnish or strengthen the mechanical connection to the clutch disk.

The pressing force-generating element of the clutch is often constructed in such a way that it causes a pressing force along the axial direction between the second structural component part and the clutch disk so that the torque can be transmitted between the latter by the resulting static friction. More precisely, the pressing force-generating element is often constructed in such a way that the pressing force between the second structural component part and the clutch disk is first caused or correspondingly increased only when the second structural component part enters into mechanical interaction with the pressing force-generating element as a result of the increased distance between the first structural component part and the second structural component part. The pressing force-generating element can comprise, for example, a disk spring or diagram spring, and the force is caused by a deformation of the diaphragm spring or disk spring resulting from the increased distance between the first structural component part and second structural component part.

However, the pressing force-generating element can also be a constructional unit which includes one or more coil springs and in which a mechanical deformation of the one or more coil springs is likewise caused by the increased distance between the first structural component part and second structural component part. In other pressing-force generating elements, pneumatic spring elements, elastic spring elements or other mechanical spring elements can also be used. In other words, the pressing force-generating element of the clutch is generally constructed in such a way that as a result of the increase in the distance between the first structural component part and second structural component part the pressing force is transmitted from the pressing force-generating element via the centrifugal unit to the clutch disk or is present therebetween. In other words, the pressing force-generating element is constructed in such a way that when the distance increases between the first structural component part and second structural component part of the centrifugal unit the pressing force is exerted along the axial direction on the centrifugal unit and clutch disk and accordingly allows torque to be transmitted.

Further, the pressing force-generating element is often constructed in such a way that the pressing force can be interrupted or at least reduced by a further mechanical interaction. The further mechanical interaction can be caused, for example, by a disengagement unit. In case a pressing force-generating element comprises a disk spring or diaphragm spring, the disengagement unit can cause the further mechanical interaction on the diaphragm spring or disk spring in such a way, for example, that the latter reduces or even completely eliminates the pressing force due to a lever action. Also, as regards the pressing-force generating elements to be described further, i.e., based, for example, on the above-described pressing-force generating elements based on coil springs or pneumatic spring elements, the pressing force can be reduced or completely eliminated by the further mechanical interaction by a corresponding lever arrangement.

In this regard, the axial direction corresponds in general to the direction of torque transmission and accordingly coincides with the axes of rotation or shafts of the given components. Accordingly, the first structural component part, the second structural component part, the clutch disk and the pressing force-generating element are often constructed so as to be substantially symmetrical with respect to rotation, which allows a coaxial transmission of torque along the axial direction, i.e., along the common axes.

The return spring element can be constructed in such a way that it causes a force between the first structural component part and the second structural component part of a magnitude such that the distance between the first structural component part and the second structural component part increases along the axial direction only when the limiting rotational speed is exceeded.

In a centrifugal unit according to an embodiment of the invention, the first structural component part and the second structural component part can be further constructed in such a way that the distance between the first structural component part and the second structural component part along the axial direction increases to a lesser extent when a further limiting rotational speed is exceeded as rotational speed continues to increase. This can make it possible, for example, to limit an increase in the dimensions of the centrifugal unit along the axial direction and thus, for example, to limit the pressing force generated by the pressing force-generating element and/or a mechanical deformation thereof. In this way it is also possible that a rotational speed at which a clutch with a centrifugal unit according to an embodiment example engages is configured to be different than a rotational speed at which the given clutch with the centrifugal unit disengages again. This makes it possible, for example, to cause a hysteresis with respect to the transmissible torques and with respect to the pressing force, which often run linear to one another, so that an engagement speed at which the clutch closes can be higher than a disengagement speed at which the clutch disengages or opens again.

In a centrifugal unit according to an embodiment of the invention, the first structural component part can have a running path and the second structural component part can have an opposing running path for a centrifugal element, wherein the running path and the opposing running path extend along a radial direction at the first structural component part and second structural component part, and wherein the running path and the opposing running path each have a portion running obliquely to one another in axial direction. The portion of the running path and the portion of the opposing running path run toward one another with increasing distance from the axial direction. The centrifugal element is formed so as to move along the running path and the opposing running path during rotation of the centrifugal unit around the axial direction due to a centrifugal force acting on this centrifugal element. The radial direction extends substantially perpendicular to the axial direction. Consequently, the increase in the distance of the first structural component part from the second structural component part is caused by the described geometrical configuration of the running path and opposing running path and the centrifugal element which is movably arranged therebetween. The transmission of pressing force from the first structural component part to the second structural component part and further to the clutch disk runs in axial direction substantially also via the centrifugal element.

In other embodiments, a plurality of running paths, opposing running paths and centrifugal elements can be implemented in a corresponding manner. For example, a centrifugal unit can have six running paths, six opposing running paths and six centrifugal elements, but also any other quantity of running paths, opposing running paths and centrifugal elements.

Further, in a centrifugal unit of this kind the running path and the opposing running path can each have a further portion arranged behind the portions of the running path and opposing running path along the radial direction with increasing distance from the axial direction. The further portions of the running path and opposing running path can run obliquely relative to one another at a smaller angle than the first-named portions of the running path and opposing running path. The further portion of the running path and the further portion of the opposing running path run toward one another at increasing distance from the axial direction. The above-described reduction in the increase in distance of the first structural component part and second structural component part can be achieved in this way when the rotational speed of the centrifugal unit exceeds the further limiting speed.

In a centrifugal unit of this kind, the ratio of the angles between the portions and the further portions of the running path and opposing running path can be at least 3:1 and/or the angle between the further portions of the running path and opposing running path is at most 10° and/or the angle between the portions of the running path and opposing running path is at least 20°. By implementing one or more of these constructions, the engaging speed and/or the disengaging speed, for example, can be adjusted in such a way that a clutch with a centrifugal unit according to the embodiment of the invention does not necessarily slip even when driving at low rpm.

In a centrifugal unit according to an embodiment of the invention, the running path and/or the opposing running path can have an outer radial stop which limits a movement of the centrifugal element or centrifugal elements along the radial direction to a maximum distance value from the axial direction. In this way, in cooperation with the inclinations of the portions and further portions of the running path and opposing running path, a maximum distance value is defined which limits a maximum pressing force on the one hand and/or a maximum deformation of the pressing force-generating element or components thereof on the other hand. A maximum transmissible torque and/or a mechanical load of the pressing force-generating element or other components of a corresponding clutch can be limited in this way.

In a centrifugal unit according to an embodiment of the invention, the running path and/or the opposing running path can further have an inner radial stop which limits a movement of the centrifugal element or centrifugal elements along the radial direction to a minimum distance value from the axial direction in such a way that the centrifugal element or centrifugal elements already contact(s) the portions of the running path and opposing running path when the centrifugal unit is at a standstill. In this way, a starting behavior of a clutch with a centrifugal unit according an embodiment example can be improved, if necessary, in that the centrifugal element or centrifugal elements already contact(s) the inclined portion so that a change in the rotational speed of the centrifugal unit is immediately accompanied by a change in the distance of the first structural component part and second structural component part of the centrifugal unit without the centrifugal element or centrifugal elements having to first arrive at the corresponding portion. Noise generation can also be positively influenced in this way, if required, because the centrifugal element or centrifugal elements are/is located in a defined position between the inner radial stop and the portion of the running path or opposing running path even at very low rotational speeds of the centrifugal unit.

In a centrifugal unit according to an embodiment of the invention, the centrifugal element can comprise a first substantially rotationally symmetrical body portion and a second substantially rotationally symmetrical body portion, wherein the first body portion contacts the running path and the second body portion contacts the opposing running path. The first body portion and second body portion are supported relative to one another by a plain bearing or a rolling element bearing, for example, a needle bearing. In this way, it can be possible, if required, to cause a transmission of the pressing force via the centrifugal unit with less friction because the two body portions of the centrifugal element or centrifugal elements can move between the running path and the opposing running path with less friction due to its/their rotationally symmetrical construction and bearing support. A response behavior of the centrifugal unit and, therefore, of a clutch having a centrifugal unit of this kind according to an embodiment example, and the energy efficiency and, therefore, an efficiency of the clutch can be improved in this way.

In a centrifugal unit according to an embodiment of the invention, the centrifugal element can be arranged at least partially outside of the clutch disk in radial direction in an operating condition. In other words, the centrifugal element or centrifugal elements can be arranged so as to be outwardly offset in radial direction with respect to the clutch disk. In this way, if necessary, a clutch with a centrifugal unit can be implemented which undergoes no increase or only a slight increase with respect to its axial dimensioning compared to a conventional clutch. A clutch of this kind can be used, for example, in applications in which the axial installation space in particular is a decisive criterion. Accordingly, a clutch of this kind with a corresponding centrifugal unit according to an embodiment example can be used, for example, in compact cars or other motor vehicles in which the engine and/or transmission are installed transverse to the driving direction.

In a centrifugal unit according to an embodiment, the centrifugal element or centrifugal elements can project beyond the clutch disk in radial direction not at all or by no more than a greatest radius of the centrifugal element or centrifugal elements under all operating conditions. In other words, in a centrifugal unit of this kind the centrifugal element or centrifugal elements can be arranged in axial direction relative to the clutch disk, which can be advantageous, for example, in application scenarios in which the radial installation space in particular is a decisive criterion. Particularly in the field of car racing, it can be advantageous, for example, to select a corresponding arrangement of the centrifugal element or centrifugal elements in the interior of the centrifugal unit. Further, it can also be possible, as the case may be, to simplify the centrifugal unit in terms of construction in a case such as this because the occurring forces need no longer be transmitted along the radial direction to a point outside the diameter of the clutch disk so that occurring bending moments of the structural component parts and components of the centrifugal unit can be reduced if necessary.

A centrifugal unit according to an embodiment of the invention can be constructed in such a way that it can be inserted in a housing cage with a pressing force-generating element which is constructed in such a way that when the distance of the first structural component part from the second structural component part of the centrifugal unit increases it exerts a pressing force along the axial direction on the centrifugal unit and clutch disk so that torque can be transmitted. Accordingly, a centrifugal unit according to an embodiment example can be constructed as a pressure plate of a motor vehicle clutch, for example, of a single-disk dry clutch. However, it can also be used in connection with a friction pack having more than one clutch disk and/or a plurality of inner and outer disks such as is used, for example, in the field of car racing but also in other clutches in which large amounts of torque must be transmitted.

In a clutch according to an embodiment of the invention, the centrifugal unit can always contact the pressing force-generating element at least in a wear-free state. In this way, if necessary, a response behavior of the centrifugal unit can be improved compared to a solution in which a distance from the pressing force-generating element must first be overcome before the pressing force can be transmitted to the clutch disk.

In a clutch according to an embodiment of the invention, the pressing force-generating element can include a disk spring or diaphragm spring which is arranged in a pre-loaded state in the housing cage. In this way, a greater pressing force can be transmitted to the clutch disk, and torque transmission can therefore be increased, by an even smaller increase in the distance of the first structural component part from the second structural component part of the centrifugal unit because of the pre-loading.

In a clutch according to an embodiment of the invention, the disengagement unit can have a pre-load spring element which is so constructed and arranged that the disengagement unit always contacts the pressing force-generating element in such a way that the disengagement unit allows the mechanical connection between the clutch disk and the centrifugal unit to be disengaged substantially immediately in time. In this way, actuation of the disengagement unit substantially immediately leads to the further mechanical interaction with the pressing force-generating element, which can result in a reduction of the pressing force and, therefore, in a reduction, or even an interruption, of the torque transmission. Accordingly, it may not be necessary to first overcome a play that depends on the operating condition of the clutch or centrifugal unit, as the case may be. In this way, a gear change can possibly be carried out with less wear and in a reproducible manner because an interruption of torque transmission, i.e., a disengagement, can take place under defined conditions.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The exemplary embodiments of the present invention are described with reference to the following figures:

FIG. 1 shows an exploded view in cross section through a clutch according to an embodiment example with a centrifugal unit according to an embodiment of the invention.

FIG. 2 shows a cross section through a clutch with a centrifugal unit according to an embodiment of the invention.

FIG. 3 shows an enlarged detail of the centrifugal unit according to an embodiment of the invention in the area of the centrifugal element.

FIG. 4 shows a perspective view of a centrifugal element of the centrifugal unit.

### DETAILED DESCRIPTION OF THE PRESENTLY PREFERRED EMBODIMENTS

Within the framework of the present description, summarizing reference numerals will be used for objects, structures and other components when describing the given component by itself or a plurality of corresponding components within an embodiment example or within more than one embodiment example. Therefore, parts of the description which pertain to a component are also transferable to other components in other embodiment examples unless explicitly stated otherwise or unless this follows from the context. When individual components are designated, individual reference numerals are used which are based on the corresponding summarizing reference numerals. Therefore, same reference numerals designate same or comparable components in the following description of embodiment forms.

Components occurring multiple times in an embodiment example or in different embodiment examples may be constructed or implemented identically and/or differently as regards some of their technical parameters. For example, it is possible that a plurality of components within an embodiment example can be constructed identically with respect to one parameter but differently with respect to another parameter.

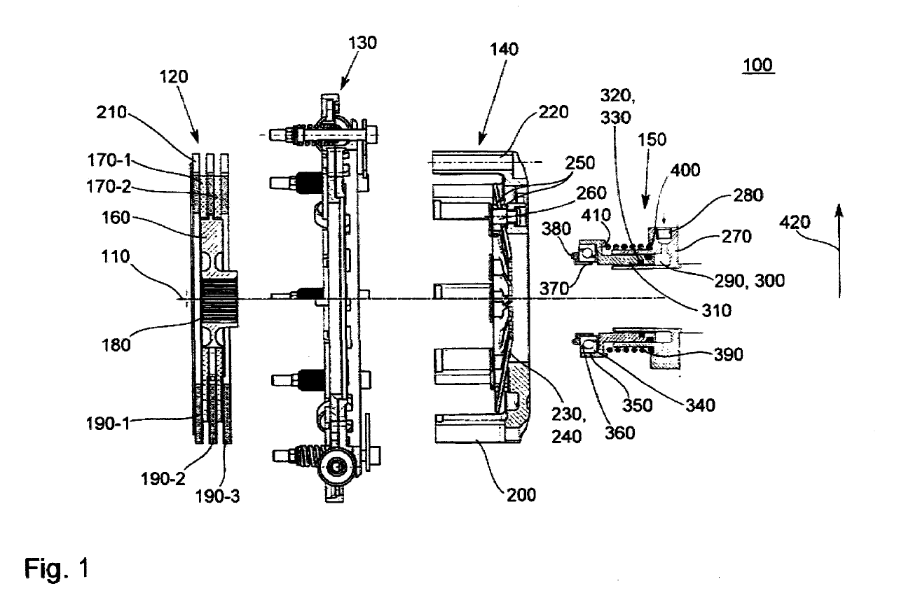

FIG. 1 shows an exploded cross-sectional view through a clutch 100 according to an embodiment in which the individual principle component groups of the clutch 100 are shown offset along a common axial direction 110. The clutch 100 includes a friction pack 120, a centrifugal unit 130, a housing cage 140 and a disengagement unit 150.

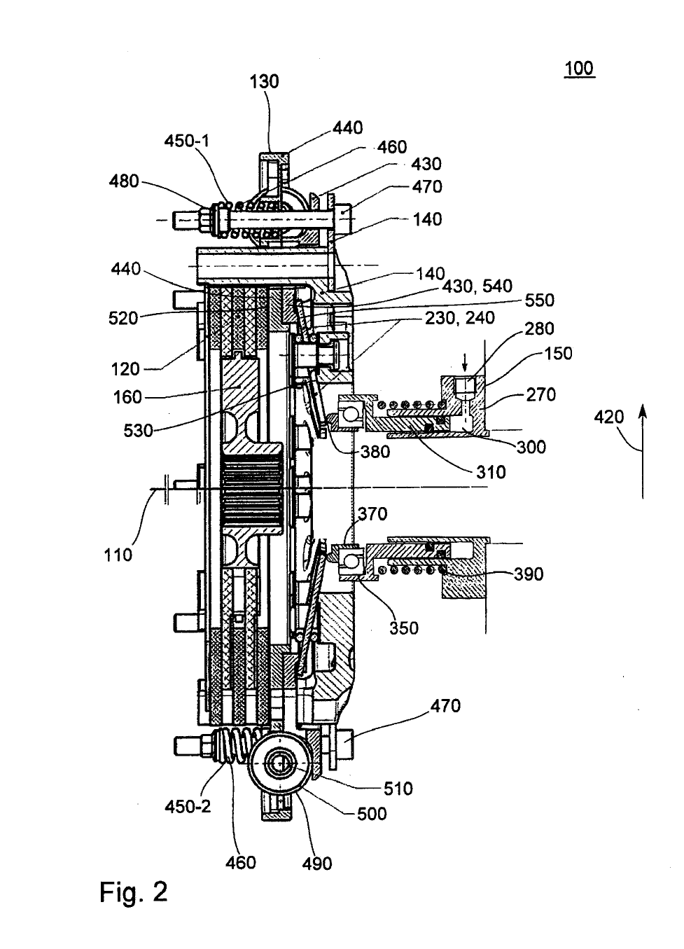

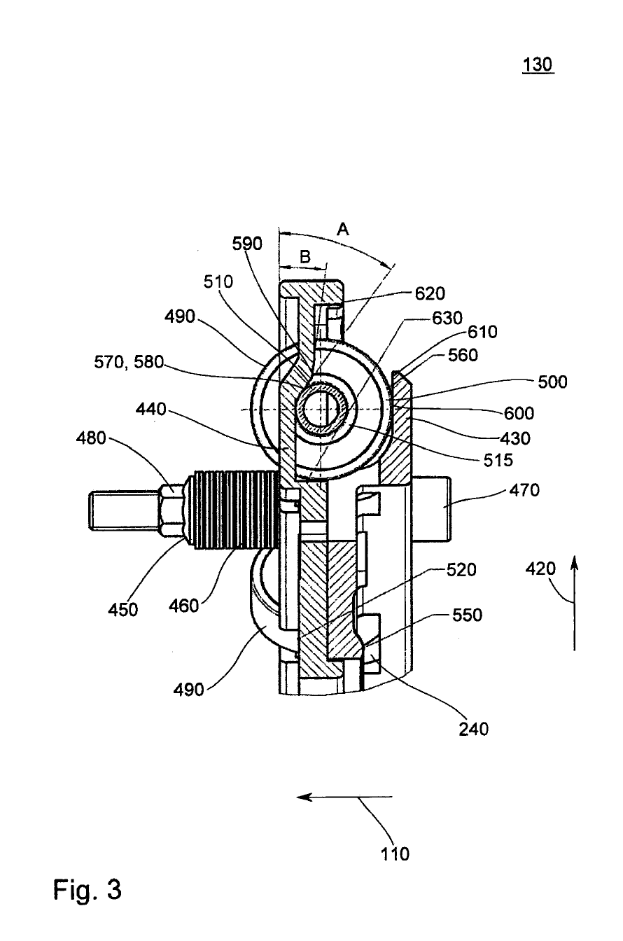

While the centrifugal unit 130 will be described in more detail with respect to its construction and functioning particularly in connection with FIGS. 2 and 3, it is opportune at this juncture to describe the friction pack 120, the housing cage 140 and disengagement unit 150 more closely in terms of their construction.

The friction pack 120 comprises a clutch disk 160 having a plurality of inner disks 170-1, 170-2. The inner disks 170 are connected to the clutch disk 160 so as to be fixed with respect to rotation relative to it, but may be displaceable along the axial direction 110 if required. The clutch disk 160 further has a hub 180 by which the clutch disk 160 can be connected to a transmission input shaft or other shaft so as to be fixed with respect to rotation relative to it. The clutch disk 160 is correspondingly aligned substantially rotationally symmetric to the axial direction 110.

The friction pack 120 further comprises a plurality of outer disks 190-1, 190-2 and 190-3 which are so arranged and constructed that they can each be brought into contact alternately with the inner disks 170-1, 170-2. The outer disks 190-1, 190-2, 190-3 are arranged so as to be fixed with respect to rotation relative to one another by the housing cage 140, but so as to be displaceable relative to one another in axial direction 110. The inner disks 170-1, 170-2 and outer disks 190-1, 190-2, 190-3 can optionally have, partially or in their entirety, a friction facing so that a static friction coefficient between the outer disks 190-1, 190-2, 190-3 and the inner disks 170-1, 170-2 when a pressing force acting along the axial direction 110 is applied can possibly be increased relative to corresponding inner and outer disks (170-1, 170-2), (190-1, 190-2, 190-3) which do not have a corresponding friction facing.

The housing cage 140 is constructed in such a way that it receives not only the outer disks 190-1, 190-2, 190-3 but also the centrifugal unit 130 so as to be fixed with respect to relative rotation but axially displaceable, i.e., displaceable along the axial direction 110. To this end, the housing cage 140 has a plurality of rod-shaped elements 200 by which the outer disks 190-1, 190-2, 190-3 can be coupled to the housing cage 140 so as to be fixed with respect to rotation relative to it by corresponding recesses 210, for example, lugs.

Depending on the specific construction of the housing cage 140, the rod-shaped elements 200, but also other elements of the housing cage 140, as the case may be, can comprise bore holes 220 or other fastening structures by which the housing cage 140 can be mechanically connected to a flywheel of an engine or other driven component so as to be fixed with respect to relative rotation. Accordingly, in the embodiment of a clutch 100 shown in FIG. 1, the housing cage 140 can be mechanically connected, e.g., screwed, to a flywheel, not shown in FIG. 1.

The housing cage 140 has a pressing force-generating element 230 in the form of a pre-loaded diaphragm spring 240 which is riveted into the housing cage 140. The diaphragm spring 240 is arranged in the housing cage 140 so as to be pre-loaded by two tilt rings 250 constructed as wire rings. More precisely, the diaphragm spring 240 is riveted to the housing cage 140 via a fastening ring 260.

The disengagement unit 150 has a housing 270 with a hydraulic connection 280 and a recess 290 which forms the working chamber 300 of the disengagement unit 150. The housing 270 is also referred to as slave cylinder.

A piston 310 having a sealing element 330 in the form of an O-ring in two ring-shaped grooves 320 is arranged in the recess 290. The two O-rings or sealing elements 330 seal the working chamber 300 against leaking of hydraulic fluid from the working chamber 300. The piston 310 is connected to an outer ring 340 of a rolling element bearing 350 which is a four point bearing in the embodiment example shown in FIG. 1. However, in other embodiment examples other rolling element bearings, possibly also plain bearings, can be used if required. An inner ring 360 of the rolling element bearing 350 is coupled with a disengagement ring 370 having a disengagement knife edge 380 facing in axial direction 110.

Further, a pre-load spring element 390, also referred to as pre-loading spring or pre-tensioning spring, is arranged between the housing 270 and the piston 310 and compressively pre-loaded along the axial direction 110. The pre-load spring element 390 is arranged in a groove 400 in housing 270 and in a corresponding counter-groove 410 of housing 270 so as to ensure that the pre-load spring element 390 cannot slip perpendicular to the axial direction 110, i.e., along a radial direction 420.

The disengagement unit 150 and pre-load spring element 390 thereof are so constructed and arranged that the disengagement unit 150 is always in contact with the pressing force-generating element 230, i.e., the diaphragm spring 240. In this way, the disengagement unit 150 can disengage the mechanical connection directly between the clutch disk 160 and the centrifugal unit 130 as will be described in more detail referring to FIG. 2. However, before describing the internal structure of the centrifugal unit 130 in more detail with reference to FIG. 2, it should be mentioned at this point that the centrifugal unit 130, the housing cage 140 and the disengagement unit 150 each have a central bore hole through which the transmission input shaft or another shaft can be guided so as to be connectable to the hub 180 of the clutch disk 160. A collinear or coaxial arrangement of the transmission input shaft and crankshaft or other shaft which is mechanically connected to the housing cage 140 via bore holes 220 can be guided in this way.

FIG. 2 shows a cross-sectional view through the clutch 100 of FIG. 1 according to an embodiment example in assembled state. The centrifugal unit 130 has a first structural component part 430, also referred to as upper part, and a second structural component part 440, also referred to as lower part. The second structural component part 440 is coupled to the first structural component part 430 so as to be fixed with respect to rotation relative to it with respect to the axial direction 110. The first structural component part 430 and the second structural component part 440 are substantially disk-shaped or plate-shaped. The centrifugal unit 130 and, therefore, the clutch 100 further include a plurality of return spring elements 450 which are configured to cause a force between the first structural component part 430 and second structural component part 440 in such a way that a distance between the first structural component part 430 and second structural component part 440 along the axial direction 110 adopts a neutral value when the centrifugal unit 130 is at a standstill, i.e., at a rotational speed of about 0 l/min. The return spring element 450 can be constructed in such a way that it causes a force between the first structural component part 430 and the second structural component part 440 of a magnitude such that the distance between the first structural component part 430 and the second structural component part 440 along the axial direction 110 first increases when the limiting rotational speed is exceeded.

The diagram in FIG. 2 shows two return spring elements 450-1 and 450-2. More precisely, the clutch or centrifugal unit 130 thereof shown in FIG. 1 includes a total of six return spring elements 450; in other embodiment examples of a clutch 100, there can be a greater or smaller quantity of corresponding return spring elements 450. For example, a centrifugal unit 130 can also have only one individual return spring element 450, but can also have a greater or smaller quantity than the two values mentioned above.

The return spring elements 450 of the centrifugal unit 130 in FIG. 2 are based on the use of coil springs 460 which are constructed as compression springs. Owing to the mechanical connection thereof to the first structural component part 430 and second structural component part 440, they make it possible to press the first structural component part 430 and second structural component part 440 toward one another. To make this possible, the return spring elements 450 have a screw 470 at which the coil spring 460 is supported by a support part 480 as is shown in FIG. 2. The support part 480 can be formed in this case, for example, by a sleeve that can be arranged on the screw 470 and a nut, but can also be formed by a correspondingly constructed structural component part having a correspondingly shaped support surface for the coil spring 460. The coil spring 460 is supported at the second structural component part 440 at a corresponding support surface surrounding a bore hole.

More precisely stated, in the embodiment example of a centrifugal unit 130 shown in FIG. 2, the above-described force exerted by the return spring element 450 between the first structural component part 430 and second structural component part 440 is produced in that the first structural component part 430 in the assembled state has, in addition to the bore hole mentioned above, a bore hole which is arranged around the supporting surface of the second structural component part 440 and through which the screw 470 extends. Further, the screw 470 extends through a bore hole in the housing cage 140 and is supported at a support surface of the housing cage 140. Accordingly, the force causing the decrease in distance between the first structural component part 430 and second structural component part 440 along the axial direction 110 is brought about in this case in that the coil spring 460 is compressively pre-loaded and, owing to the mechanical connection thereof via the support part 480 and the fastening thereof to the housing cage 140, the second structural component part 440 (lower part) presses in direction of the first structural component part 430 (upper part). In so doing, the force is conveyed from the second structural component part 440 to the first structural component part 430 by centrifugal elements arranged therebetween. The screws 470 shown in FIG. 2 which are pre-loaded by the coil springs 460 are accordingly connected to the housing cage 140 by lugs so that the entire centrifugal unit 130 is pressed against the diagram spring 240 or, in case a different pressing force-generating element 230 is implemented, against the latter. In other embodiments, possibly only some of the respective screws 470 can be connected to the housing cage 140 in a corresponding manner via bore holes or lugs.

As will be described in even more detail in connection with FIG. 3, the centrifugal elements 490 run along a running path at the first structural component part 430 and an opposing running path of the second structural component part 440. In this instance, the running paths extend substantially along the radial direction 420 and have, respectively, at least one portion extending obliquely relative to one another in axial direction 110 in such a way that the corresponding portions of the running path and opposing running path run toward one another with increasing distance from the axial direction 110, i.e., with increasing radius from the central bore hole in the center of the centrifugal unit 130. The centrifugal elements 490 are so constructed in this instance that during a rotation of the centrifugal unit 130 around the axial direction 110 they can move outward, i.e., to increasingly greater radii, along the running path and opposing running path due to a centrifugal force acting on them.

In principle, the quantity of centrifugal elements 490 can be optional. Thus one individual corresponding centrifugal element 490 in a centrifugal unit 130 may already be sufficient as the case may be. However, in other embodiments it may be advisable to use more than one centrifugal element 490, for example, two or more, centrifugal elements 490 just to achieve a radially symmetrical weight distribution. Thus in the embodiment example of a centrifugal unit 130 shown in FIGS. 1 and 2, six centrifugal elements 490 are implemented, for example. Particularly when using return spring elements 450 based on coil springs 460 as was described above, it may be advisable, for example, to establish a fixed relationship between the quantity of centrifugal elements 490 and the number of return spring elements 450. For example, exactly one centrifugal element 490 can be allocated to each return spring element 450 so that the quantity of return spring elements 450 corresponds to that of the centrifugal elements 490. In other embodiments, however, a plurality of centrifugal elements, for example, two centrifugal elements 490, can also be allocated to a return spring element 450, or a plurality of return spring elements 450, e.g., two, can be allocated to each centrifugal element 490 so that the quantity of implemented return spring elements 450 to the quantity of implemented centrifugal elements 490 amounts to a natural number or a reciprocal of a natural number, i.e., 2, 1 or ½, for example.

Through the use of the running paths and opposing running paths described briefly above, between which the centrifugal elements 490 run, the second structural component part 440 and the first structural component part 430 are consequently constructed in such a way that a distance between these two structural component parts 430, 440 increases along the axial direction 110 when a limiting rotational speed is exceeded starting from a neutral value when the centrifugal unit 130 is at a standstill. In this case, the limiting rotational speed depends, for example, on a force caused by the coil springs 460 of the return spring elements 450. In other embodiments, however, this functionality can be also be realized without the use of centrifugal elements 490, for example, by using toggle constructions.

The centrifugal elements 490 have a first body portion 500 and a second body portion 510, both of which are constructed so as to be substantially rotationally symmetrical. In the embodiment of a centrifugal unit 130 shown in FIG. 2, the two body portions are substantially barrel-shaped or roller-shaped. The first body portion 500 contacts the running path of the first structural component part 430, i.e., the upper part, while the second body portion 510 contacts the opposing running path of the second structural component part 440, i.e., the lower part. The two body portions 500, 510 can be rotatably supported relative to one another, for example, by a rolling element bearing 515. In order to realize a compact construction, the two body portions 500, 510 can be supported relative to one another by a needle bearing, for example. Alternatively or in addition, the two body portions can also be rotatably supported relative to one another by a plain bearing.

In view of the fact that the centrifugal elements, by reason of their interaction with the running path and the opposing running path of the two structural component parts 430, 440 in the embodiment example of a centrifugal unit 130 shown in FIGS. 1 and 2, provide for the change in distance between the two structural component parts 430, 440, these centrifugal elements are also referred to as centrifugal weights or, more briefly, weights. The exact configuration and implementation of the running paths and opposing running paths and the functional features resulting therefrom are described more fully in connection with FIG. 3.

The second structural component part 440 is formed to provide a mechanical connection via the friction pack 120, i.e., via the clutch disk 160, for transmitting a torque. To this end, the second structural component part 440, i.e., the lower part, has a pressing surface 520 which is so constructed and arranged in the embodiment example of a centrifugal unit 130 and corresponding clutch 100 shown in FIGS. 1 and 2 that this pressing surface 520 can exert a pressing force on an outer disk 190, more precisely, outer disk 190-3 of the friction pack 120. The pressing surface 520 is at least partially annular and can optionally be provided with an additional friction facing. The pressing surface 520 extends substantially perpendicular to the axial direction 110. More precisely, the pressing surface 520 of the lower part, i.e., of the second structural component part 440, in the embodiment shown in FIGS. 1 and 2 is at least partially circular. Deviations from the circular shape can be carried out depending on design, for example, in order to accommodate bore holes or other components, but also depending on function, for example, for reducing weight, for providing cooling channels, or for other reasons. Thus the second structural component part 440 can have, for example, a plane underside which faces the friction pack 120 and clutch disk 160 and which can extend, for example, substantially perpendicular to the axial direction 110 in order to press on the friction pack 120.

The first structural component part 430, i.e., the upper part, is constructed in this instance to contact or be brought into contact with the pressing force-generating element 230, i.e., the diaphragm spring 240 of the clutch 100, so that the mechanical connection to the clutch disk 160 can be furnished or strengthened through the increase in the distance between the first structural component part 430 and the second structural component part 440 by means of the pressing force-generating element 230. The mechanical connection which makes the transmission of torque possible is a force-fitting or frictionally engaging connection as was already mentioned above; that is, it is based on the phenomenon of static friction and thus requires a corresponding pressing force which is provided by the pressing force-generating element 230 in the axial direction 110 when acted upon in a corresponding manner or upon demand.

Accordingly, as was already described in connection with FIG. 1, the diaphragm spring 240 as pressing force-generating element 230 is riveted into the housing cage 140, where the diaphragm spring 240 is held in a pre-loaded manner at the housing cage 120 by means of a stop 530.

To this end, the first structural component part 430 has a portion 540 which contacts the second structural component part 440 in the condition shown in FIG. 2 in which the distance along the axial direction 110 of the two structural component parts 430, 440 adopts the neutral value. This portion of the first structural component part 430 has an annular knife edge 550 that is pressed against the pre-loaded diaphragm spring 240. Accordingly, when the distance changes between the first structural component part 430 and the second structural component part 440 along the axial direction 110, the diaphragm spring 240 is deformed so that it exerts a pressing force along the axial direction 110 on the first structural component part 430, which pressing force conveys the latter via the centrifugal elements 490 to the second structural component part 440 and, via the pressing surface 520, to the friction pack 120.

Of course, in other embodiments of a centrifugal unit 130 or a clutch 100 the knife edge 550 can also be arranged at a portion other than the portion contacting the second structural component part 440. Moreover, in case the pressing force-generating element 230 is realized in a different manner, an entirely different mechanism can also be used to produce the pressing force.

The use of a centrifugal unit 130 according to an embodiment within the framework of a clutch 100 according to an embodiment also makes it possible, among other things, to use the disengagement unit 150 to interrupt the torque transmission. As has already been described in connection with FIG. 1, the disengagement unit 150 has the disengagement ring 370 with the disengagement knife edge 380 which is pressed against the diaphragm spring 240 by the pre-load spring element 390. Accordingly, when the disengagement unit 170 is actuated, i.e., when hydraulic fluid is introduced into the working chamber 300 via the hydraulic connection 280, the piston 310 can be displaced along the axial direction so that the disengagement knife edge 380 or disengagement ring 370 deforms the diaphragm spring 240 in such a way, or enters into interaction with it in such a way, that this diaphragm spring 240 now exerts no force, or at least exerts a reduced force, on the portion 540 of the first structural component part 430. Accordingly, the working force acting on the friction pack 120 and clutch disk 160 is also reduced so that the torque transmission is reduced if not interrupted.

As has already been described, the disengagement unit 150 comprises the typically weakly designed pre-load spring or pre-tension spring (pre-load spring element 390) which constantly presses the piston 310 and, therefore, the disengagement knife edge 380 against the diaphragm spring tongues. When pressure impinges on the working chamber 300, as was described above, the piston 310 is accordingly pressed against the diaphragm spring 240 and the clutch 100 is released. The disengagement unit 150 and the pre-load spring 390 thereof are accordingly constructed in such a way that the disengagement unit 150 always contacts the pressing force-generating element 230 in such a way that the disengagement unit 150 allows the mechanical connection between the clutch disk 160 and the centrifugal unit 130 to be disengaged immediately, i.e., without overcoming any significant play. The centrifugal unit 130 is constructed in such a way that it is in constant contact with the pressing force-generating element 230 under wear-free condition. In this way, a starting behavior or engagement behavior of the clutch 100 can be improved, if necessary, in that a play or other dead space of the centrifugal unit 130 need not be overcome first when the distance increases along the axial direction 110.

Accordingly, the disengagement unit 150 in its entirety is so arranged and constructed that it can eliminate or reduce a force or pressing force exerted by the pressing force-generating element 230 so that the mechanical connection between the clutch disk 160 and the centrifugal unit 130 can be disengaged.

Before describing the construction of the running path and opposing running path in more detail referring to FIG. 3, it should be mentioned at this point that the centrifugal unit 130 shown in FIGS. 1 and 2 is a centrifugal unit for a clutch 100 that is used in an environment in which axial installation space, i.e., the installation space along the axial direction 110, is limited. Compared to a conventional pressure plate, for example, the centrifugal elements 490 in the embodiment form shown here are arranged at least partially outside the clutch disk 160 in radial direction at least in an operating condition. In other words, the additional components of the centrifugal unit 130 which are responsible for engagement during the rotation thereof are arranged radially adjacent to the clutch disk 160 or friction pack 120. Consequently, compared to a conventional pressure plate, this construction requires additional installation space in radial direction. An arrangement of this kind can be used in a meaningful way, for example, in connection with a compact car or other motor vehicle in which the axial installation space is limited because a transverse installation of engine and/or transmission. Of course, a corresponding construction can also be used in other application scenarios in which the axial installation space is also limited.

In the clutch 100 shown in FIGS. 1 and 2, the corresponding centrifugal elements 490 are arranged at least partially outside the clutch disk 160 in radial direction even under all operating conditions. If a dislocation which may possibly occur in axial direction 110 is not taken into account, the centrifugal elements 490 in the embodiment form shown here are even arranged completely outside of the clutch disk 160 in radial direction under all operating conditions because the position of the centrifugal elements 490 shown in FIGS. 1 and 2 corresponds to the neutral position, i.e., they are at their shortest radial distance.

In contrast, in other centrifugal units 130 and another corresponding clutch 100 according to an embodiment, the centrifugal element or centrifugal elements 490 can project beyond the clutch disk 160 in radial direction either not at all or by no more than a greatest radius of the centrifugal element 490 under all operating conditions. In such a case, accordingly, the additional components of the centrifugal unit 130 are arranged in axial direction compared to a conventional pressure plate. In this way, radial installation space can be spared compared to the arrangement shown in FIGS. 1 and 2, which can be useful, for example, in sport cars and in car racing.

FIG. 3 shows a partial enlargement of the centrifugal unit 130 in the region of a centrifugal element 490. As was already explained, the first structural component part 430 has a running path 560 and the second structural component part 440 has an opposing running path 570. The centrifugal element 490 can roll along the running path 560 with the first body portion 500, i.e., the larger of the two rollers, while the second body portion 510 can contact the opposing running path 570 and roll along the latter.

The second structural component part 440, i.e., the lower part, has two inclines which merge into one another and are part of the opposing running path 570. More precisely, the opposing running path 570 has a portion 580 extending at a first angle and a further portion 590 which adjoins the latter and extends at an another angle relative to radial direction 420. Correspondingly, the running path 560 also has a portion 600 which adjoins a further portion 610. With respect to the contact points of the centrifugal elements 490 while rolling along the running path 560 and opposing running path 570, respectively, portion 600 is associated with portion 580, while further portion 610 is associated with further portion 590 of running path 560.

In the embodiment example of a centrifugal unit 130 shown in FIGS. 1 to 3, however, portion 600 and further portion 610 do not have different angles. More precisely, the running path 430 of the upper part or first structural component part 430 in this region has a plane face at which the centrifugal element 490 can roll along with the first body portion 500. In contrast, the second structural component part 440, i.e., the lower part, has rectangular cutouts in which the opposing running path 570 is guided, i.e., in which the weight 490 supported by rolling element bearing or plain bearing is guided.

Portion 580 of opposing running path 570 and portion 600 of running path 560 run obliquely relative to one another in axial direction 110. In so doing, portion 580 of opposing running path 570 and portion 600 of running path 560 approach one another, i.e., run toward one another, with increasing distance from the axial direction 110. The latter together form an angle A which is typically greater than an angle B formed between further portion 590 of the opposing running path 570 and further portion 610 of the running path 560. The ratio of the angle of portions 580 and 600 to the second angle of further portions 590, 610 is typically at least 3:1. In addition or alternatively, the angle between portions 580, 600 can often be at least 20°. Alternatively or in addition, the angle between further portions 590, 610 can typically be at most 10°. Accordingly, through the selection of these angle ratios, a rapid increase in the distance of the first structural component part 430 from the second structural component part 440 can be achieved at the beginning when starting, i.e., when the rotational speed of the centrifugal unit 130 increases, while a further increase in the distance can be reduced when a further limiting rotational speed is exceeded when the centrifugal element or centrifugal elements 490 exit portions 580, 600 and enter further portions 590, 610. In an embodiment example, angle A is 36° and angle B is 7.5°, for example.

The use of a portion and a further portion with different slopes within the framework of the running path 560 and opposing running path 570 also allows a hysteresis with respect to the transmissible torque or the acting pressing force as a function of the rotational speed of the centrifugal unit 130. Accordingly, owing to the different angle ratios in portions 580, 600 compared to further portions 590, 610, a typically higher engagement speed is required, at which the centrifugal element or centrifugal elements 490 have moved along portion 580 and portion 600, respectively, to the extent that the distance between the two structural component parts 430, 440 is increased in such a way that, as a result of the pressing force generated by the diaphragm spring 240 or the pressing force-generating element 230 along the axial direction 110, a torque transmission is made possible which is sufficient for accelerating the motor vehicle. If there is another interruption during this phase in which the rotational speed of the centrifugal unit 130 is not yet sufficient to allow the centrifugal element or centrifugal elements 490 to move into the further portion 590, 610, primarily the force effected on the first structural component part 430 and second structural component part 440 by the return spring element 450 provides for a rolling back of the centrifugal elements 490 and accordingly for a reduction of the distance between the two structural component parts. This leads in turn to a reduction or interruption of the pressing force so that clutch 100 is again disengaged.

On the other hand, once the centrifugal element or centrifugal elements 490 are forced forward into the further portion 590, 610, they are subject to a smaller incline and, therefore, downgrade force which is brought about by the return spring elements 450 first at a lower disengagement speed and causes the centrifugal elements 490 to roll back into the neutral position shown in FIG. 3. In other words, once the engagement speed falls below a typically lower value the centrifugal element or centrifugal elements 490 return to the neutral position, which is associated with a drop in the distance between the first structural component part 430 and second structural component part 440 back to the neutral value. Therefore, there is typically a rotational speed range in which it depends upon antecedent events whether the clutch 100 is engaged or released, i.e., whether the centrifugal unit 130 has a great distance or a short distance between the two structural component parts 430, 440.

Further, with respect to the opposing running path 570, the centrifugal unit 130 has an outer radial stop 620 and an inner radial stop 630 which limit a movement of the centrifugal element or centrifugal elements 490 to a maximum and minimum distance value, respectively, from the axial direction 110. In cooperation with the incline of the corresponding running path 560 and opposing running path 570, the outer radial stop 620, also referred to simply as outer stop, defines a maximum distance value between the two structural component parts 430, 440. In this way, a pressing force which is brought about by the pressing force-generating element 230, i.e., for example, the diaphragm spring 240, can be limited on the one hand, but a deformation of this component and accordingly the mechanical loading thereof can also be limited. In particular, a maximum transmissible torque can be limited in this way, if required, so that high torques can also be transmitted at high rotational speeds of the centrifugal unit 130 and clutch 100 without being uncontrolled.

The inner radial stop 630 can be arranged in such a way, for example, that it ensures that the centrifugal element or centrifugal elements 490 already contact(s) portions 580, 600 of the running path 560 and opposing running path 570 when the centrifugal unit 130 is at a standstill. In this way, a faster response of the centrifugal unit 130 and/or an improvement in comfort can be achieved because the centrifugal elements 490 are also already located in a defined position when starting the centrifugal unit 130. Any noise generated by the clutch 100 can be reduced in this way.

Of course, the corresponding stops 620, 630 can also be implemented alternatively or additionally within the framework of the running path 560. In so doing, also when this is implemented in the framework of the opposing running path 570, these stops 620, 630 can be implemented as part of the first structural component part 430 or, conversely, if implemented within the framework of the running path 560, as part of the second structural component part 440. This depends on which of the corresponding body portions 500, 510 of the centrifugal element 490 interacts with the respective stops 620, 630.

The stops 620, 630 accordingly limit the path that the weights or centrifugal elements 490 can travel radially outward along the inclines. In other words, the centrifugal element 490 has the first body portion (outer ring) which runs against the plane surface forming the running path 560, and the radial path of this first body portion is limited by stops 620 and 630. Further, centrifugal element 490 (weight) has the second body portion 510 which is supported by rolling element bearing or plain bearing relative to the first body portion 500 and which can be a shaft, for example, which rolls on the inclines or on portion 580 and further portion 590 of the opposing running path 570.

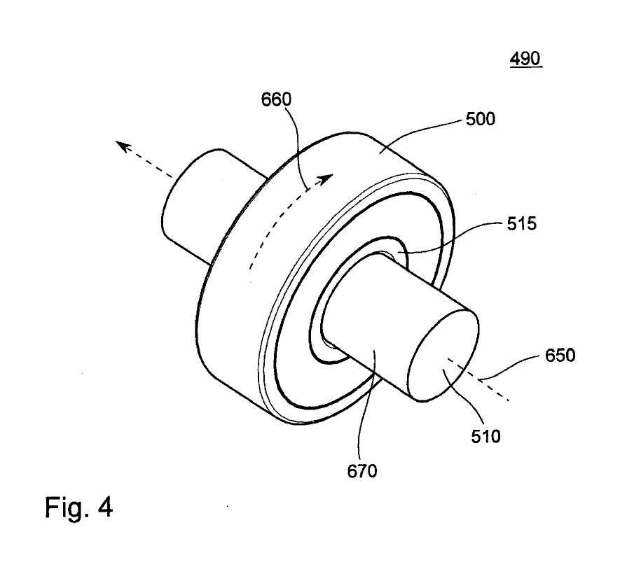

FIG. 4 shows an enlarged perspective view of a centrifugal element 490 such as is used repeatedly in the above-illustrated centrifugal unit 130 according to an embodiment. Its body portions 500 and 510 are rotatably supported relative to one another by the rolling element bearing 515. In this case, the first body portion 500 is roller-shaped with an outer-cylindrical-surface-shaped outer running surface 640 contacting the running path 560 of the first structural component part 430. The outer running surface 640 extends parallel to an axial direction 650 and a circumferential direction 660 of the first body portion 500.

Further, the first body portion 500 shown here has, in radial direction, i.e., perpendicular to the axial direction 650 and circumferential direction 660, a recess 670 which is provided at both sides of the first body portion 500 and through which, for example, a surface at which the first body portion 500 could contact the second structural component part 440, as the case may be, can be reduced.

Further, the first body portion 500 has a central bore hole with respect to the axial direction 650, the rolling element bearing 515 being inserted therein so that, by way of the outer ring thereof, the bore hole is connected to the first body portion 515. The rolling element bearing 515 accordingly allows a rotational movement of the first body portion 500 relative to the second body portion 510 around the axial direction 650. More precisely, the rolling element bearing 515 is an encapsulated needle bearing which allows a particularly compact construction and offers protection against the intrusion of solid and liquid impurities.

An inner ring of the rolling element bearing 515 is connected to the second body portion 510. This inner ring is constructed as a cylinder and can be considered as the axis of the first body portion 500. The second body portion 510 protrudes over the first body portion 500 in axial direction 650 so that the second body portion 510 can run along the opposing running path of the second structural component part 440 of the centrifugal unit 130 in the area of this overhang, i.e., can contact this opposing running path in its overhanging region. Accordingly, the second body portion also has an outer running surface 670 which is oriented parallel to the outer running surface 640 of the first body portion 500 and which contacts the opposing running path 570 of the second structural component part 440 of the centrifugal unit 130.

Of course, in other embodiment examples a plain bearing can also be used instead of the rolling element bearing 515.

As regards the function of the clutch 100 and centrifugal unit 130, it is possible to distinguish between different operating conditions. When the engine is off or only idling, the centrifugal force, which also acts upon the centrifugal elements or weights via the portions 580, 600 of the running path 560 and opposing running path 570, i.e., via the steep ramp with angle A, causes an axial force which is, however, smaller than a force caused by the pre-loaded coil springs 460 of the return spring elements 450. In this way, the first structural component part and second structural component part are held at their neutral value with respect to their distance from one another, i.e., for example, are held on one another completely. In this case, the centrifugal unit 130 can be pressed against the diaphragm spring 240 by some of the coil springs 460. They function in this case as lift springs. Because of the force ratios described above, however, no force is exerted on the friction pack 120 or on the clutch disk 160 so that the clutch 100 transmits no torque, or at least no relevant torque.

When an engagement speed is reached during starting, i.e., a rotational speed which is higher than idling speed, the axial force acting on the centrifugal weights or centrifugal elements 490 overcomes the force of the coil springs 460 of the return spring elements 450. The first structural component part 430 (upper part) presses against the pre-loaded diaphragm spring 240 and accordingly remains substantially stationary axially. The second structural component part 440 (lower part) moves in direction of the friction pack 120 and exerts a force which produces and transmits the torque required for starting.

When there is a further increase in rotational speed, the clutch 100 “catches.” If the rotational speed is increased still further, the axial force acting on the centrifugal elements 490 exceeds the forces of the coil springs 490 of the return spring elements 450 and the force of the pre-loaded diaphragm spring 240. The first structural component part 430 (upper part) presses the diaphragm spring 240 away. In this way, a greater distance occurs between the first structural component part 430 and second structural component part 440 so that the centrifugal element or centrifugal elements 490 can roll from the steeper ramp at angle A, i.e., from portions 580, 600, to the flatter ramp with angle B, i.e., to further portions 590, 610, until the centrifugal element or centrifugal elements 490 reach the outer radial stop 620. The two structural component parts 430, 440 are now pressed apart to the maximum degree and cannot be at a greater distance from one another. This behavior is also not altered when the rotational speed is further increased until a maximum permissible rotational speed.

In practice, the pressing force of the clutch 100 is also limited by means of the diaphragm spring 240, instead of a pressing force which keeps increasing substantially quadratically up to the maximum rotational speed. The housing, i.e., the housing cage 140, and the rolling element bearings and centrifugal elements 490 can be dimensioned in a simpler manner, and the maximum transmissible torque is also limited for protecting the drivetrain and additional components thereof.

In the event of a reduction in rotational speed below the engagement speed but above idling speed, i.e., if the rotational speed is reduced again, the centrifugal elements 490 are first pressed back again into the position shown in FIGS. 2 and 3 at an appreciably lower rotational speed because an appreciably smaller downgrade force acts on the weights or centrifugal elements 490 on the flatter ramp with the smaller angle B. Up to this time, the full pressing force of the diaphragm spring 240 on the friction pack 120 is available so that a slipping of the clutch 100 is prevented even at low rpm, or the probability of this is reduced.

When rotational speed decreases further until idling speed, an automatic disengagement is brought about. If the centrifugal force on the centrifugal elements 490 is now so low due to a reduction in the rotational speed of the centrifugal unit 130 that even on the flatter ramp with angle B formed by further portions 590 and 610 it is less than the downgrade forces which are also brought about at least by the return spring elements 450, the weights can roll back from the ramp B and immediately also advance over the ramp with angle A until striking the inner radial stop (end stop) 630. In this instance, the downgrade force is generated and brought about not only through the coil spring force 460 of the return spring elements 450, but rather also through the diaphragm spring 240.

Notwithstanding the speed dependency of the engagement or disengagement of the clutch 100 as a result of the centrifugal unit 130, the use of a clutch 100 with a centrifugal unit 130 according to an embodiment example also allows the clutch to be disengaged manually. Thus in every operating condition of the clutch 100 the disengagement unit 150 (clutch release) follows the spring tongues of the diaphragm spring 240 through its pre-load spring or pre-tension spring. The disengagement unit 150 can get the hydraulic volume needed for this from a compensation reservoir, for example, via a snifting bore of the master cylinder, and return it to the compensation reservoir, respectively. Accordingly, in every operating condition the first structural component part 430 (upper part) can have its “support” withdrawn by pressing the diaphragm spring 240, resulting in an interruption of the pressing force and, therefore, an interruption in the transmission of torque.

Since the extension of the centrifugal unit 130 in axial direction 110 is limited because of the construction described above, a sufficient disengagement of the diaphragm spring 240 results in a complete lift-off leading to an instantaneous interruption. The disengaging force is substantially not speed-dependent in this case. However, it may happen that the necessary disengagement path is dependent on the instantaneous position of the diaphragm spring 240, i.e., on the respective rotational speed. A corresponding stop can be provided at the housing cage 140 in the region of the outer circumference of the diaphragm spring 240 so that the diaphragm spring 240 cannot be pressed too strongly or overloaded.

The use of portions 580, 600 and further portions 590, 610 with different angles, i.e., the use of angled ramps, allows an identical disengagement path at all times once the clutch has been accelerated beyond the catching speed after starting. Thus the clutch 100 according to an embodiment and/or the centrifugal unit 130 according to an embodiment also make it possible to change gears, i.e., to release or disengage the clutch. In many cases, the disengagement force is also independent from speed because of the use of the diaphragm spring 240 or another pressing force-generating element 230. Also, by incorporating the pressing force-generating element 230, the pressing force typically does not increase quadratically with the speed, and the pressing force can have a ceiling with respect to the values that can be reached. This can also prevent a possible overloading of the drivetrain or components thereof.

The engagement speed and the disengagement speed can also be set differently. In a clutch 100 according to an embodiment, a slipping of the clutch can also be prevented even when driving at low rpm.

The clutch 100 according to an embodiment presents a centrifugal clutch with possibilities for extrinsic actuation and a limiting of pressing force which can relieve the driver of a motor vehicle through automatic engagement without resorting to an electromechanical actuating system.

Although the clutch 100 was described above exclusively in connection with the diaphragm spring 240, other types of spring can also be used within the framework of embodiment examples of a clutch 100. For example, the diaphragm spring 240 can be exchanged for a disk spring. Other pressing-force generating elements 230 based, for example, on one or more coil springs, gas-filled springs or other pneumatic or elastic spring elements can also be used. An additional mechanically implemented reduction of pressing force or interruption may possibly be necessary or advisable in this case. However, the return spring elements 450 can also be implemented, for example, based on tension springs, disk springs or other pneumatic or elastic spring elements.

The features disclosed in the preceding description, in the claims and in the drawings can be important both individually and in optional combinations for realizing embodiment examples in their various configurations and can be combined with one another in any way unless stated otherwise in the description.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A centrifugal unit for a clutch of a motor vehicle, comprising:
a first structural component part;
a second structural component part coupled to the first structural component part so as to be fixed with respect to rotation relative to the first structural component part with respect to an axial direction, wherein the first structural component part and the second structural component part are constructed such that, when a limiting rotational speed is exceeded, a distance between the first structural component part and the second structural component part increases along the axial direction starting from a neutral value when the centrifugal unit is at a standstill; and
a return spring element which causes a force between the first structural component part and second structural component part such that the distance between the first structural component part and the second structural component part adopts the neutral value when the centrifugal unit is at a standstill, wherein:
the second structural component part is mechanically connectable to a clutch disk of the clutch for transmitting a torque, and the first structural component part is cable of being brought into contact with a pressing force-generating element of the clutch so that, by way of the increased distance between the first structural component part and the second structural component part by way of the pressing force-generating element, the mechanical connection to the clutch disk is one of provided and strengthened.

2. The centrifugal unit according to claim 1, wherein the first structural component part and the second structural component part are further constructed such that the distance between the first structural component part and the second structural component part along the axial direction increases to a lesser extent when a further limiting rotational speed is exceeded as a rotational speed continues to increase.

3. The centrifugal unit first according to claim 1, wherein:
the first structural component part has a running path,
the second structural component part has an opposing running path for a centrifugal element,
the first running path and the opposing running path extend along a radial direction at the first structural component part and the second structural component part,
the first running path and the opposing running path each has respective first and second portions running obliquely to one another in the axial direction,
the second portion of the first running path and the first portion of the opposing running path run toward one another with increasing distance from the axial direction, and
the centrifugal element is formed so as to move along the first running path and the opposing running path during a rotation of the centrifugal unit around the axial direction due to a centrifugal force acting on the centrifugal element.

4. The centrifugal unit according to claim 3, wherein:
the first running path and the opposing running path each has a further portion arranged along the radial direction with increasing distance from the axial direction behind the first and second portions of the first running path and the opposing running path,
the further portions of the first running path and the opposing running path run obliquely relative to one another at a smaller angle than the first and second portions of the first running path and the opposing running path, and
the further portion of the first running path and the further portion of the opposing running path run toward one another with increasing distance from the axial direction.

5. A centrifugal unit according to claim 4, wherein at least one of:
a ratio of the angles between the first and second portions and the further portions of the first running path and the opposing running path is at least 3:1,
the angle between the further portions of the first running path and the opposing running path is at most 10°, and
the angle between the first and second portions of the first running path and the opposing running path is at least 20°.

6. The centrifugal unit according to claim 3, wherein at least one of the first running path and the opposing running path has an outer radial stop which limits a movement of the centrifugal element along the radial direction to a maximum distance value from the axial direction.

7. The centrifugal unit according to claim 3, wherein at least one of the first running path and the opposing running path has an inner radial stop which limits a movement of the centrifugal element along the radial direction to a minimum distance value from the axial direction such that the centrifugal element contacts the first and second portions of the first running path and the opposing running path when the centrifugal unit is at a standstill.

8. The centrifugal unit according to claim 3, wherein:
the centrifugal element comprises a first substantially rotationally symmetrical body portion and a second substantially rotationally symmetrical body portion,
the first body portion contacts the first running path and the second body portion contacts the opposing running path, and
the first body portion and the second body portion are supported relative to one another by one of a plain bearing and a rolling element bearing.

9. The centrifugal unit according to claim 8, wherein the one of the plain bearing and the rolling element bearing includes a needle bearing.

10. The centrifugal unit according to claim 3, wherein the centrifugal element is arranged at least partially outside of the clutch disk in the radial direction in an operating condition.

11. The centrifugal unit according to claim 3, wherein the centrifugal element protrudes over the clutch disk in the radial direction one of not at all and by no more than a greatest radius of the centrifugal element under all operating conditions.

12. The centrifugal unit according to claim 1, wherein the centrifugal unit can be inserted in a housing cage with the pressing force-generating element, when the distance of the first structural component part from the second structural component part increases, the pressing force-generating element exerting a pressing force along the axial direction on the centrifugal unit and the clutch disk so that a torque can be transmitted.

13. A clutch for a motor vehicle comprising:
a clutch disk;
a centrifugal unit according to claim 1;
a pressing force-generating element such that when the distance between the first structural component part and the second structural component part of the centrifugal unit increases, a pressing force is exerted along the axial direction on the centrifugal unit and the clutch disk so that the torque can be transmitted;
a housing cage connected to the pressing force-generating element and the centrifugal unit so as to be fixed with respect to a relative rotation; and
a disengagement unit which is so arranged and constructed that the pressing force exerted by the pressing force-generating element can be one of suppressed and reduced by the disengagement unit so that the mechanical connection between the clutch disk and centrifugal unit can be disengaged.

14. The clutch according to claim 13, wherein the centrifugal unit always contacts the pressing force-generating element in a wear-free state.

15. The clutch according to claim 13, wherein the pressing force-generating element includes one of a disk spring and a diaphragm spring arranged in a pre-loaded state in the housing cage.

16. The clutch according to claim 13, wherein the disengagement unit has a pre-load spring element which is so constructed and arranged that the disengagement unit always contacts the pressing force-generating element in such a way that the disengagement unit allows the mechanical connection between the clutch disk and the centrifugal unit to be disengaged substantially immediately in time.
